(19) United States
(12) Patent Application Publication
(10) Pub. No.: US 2015/0371618 A1
(43) Pub. Date: Dec. 24, 2015

(54) SPINABLE QUAD GUITAR STAND

(71) Applicant: ROBBIN DAVID BOWERS, JOSHUA TREE, CA (US)

(72) Inventor: ROBBIN DAVID BOWERS, JOSHUA TREE, CA (US)

(21) Appl. No.: 14/313,889

(22) Filed: Jun. 24, 2014

(51) Int. Cl. G10G 5/00

(52) U.S. Cl. CPC G10G 5/00

(57) ABSTRACT

Spinable quad guitar stand securely balances, supports, and vertically displays up to four guitars or stringed instruments of any body shape by neck and headstock, in a safe, easily accessible manner. Small footprint accommodates confined areas. Steel tripod based stand provides two or more height adjustments to accommodate standard and long bodied instruments. Stand incorporates two octagon or round wood accessory tables providing storage. Concave top table designed for high vibration environments. 360 degree spinable rotation at base, provides easy access to each instrument and desired accessories needed for various environments. Guitar cord inserts allow unprecedented control to enable speedy instrument changes. Stand collapses for storage. Manufacturing alternatives: plastic, carbon fiber, clip, pin, pipe size and thread changes. Covering alternatives: felt, wool, cloth, vinyl, leather, and neoprene.

### ASSEMBLED STAND SIDE VIEW PROTOTYPE

9/16″ diameter pipe is inserted into ⅞″ diameter pipe from bottom, extending through 9/16″ hole in cap.

Extend pipe upward far enough to expose the 7/32″ horizontal holes and insert a 5/32″ by 2+ 15/16″ hitch clip or pin through hole.

Allow hitch clip to rest on ⅞″ cap. This allows 9/16″ pipe to rotate either direction, as completed stand is turned. (To allow easy access to any of four musical instruments, mounted on stand.)

Slide table two down 9/16″ shaft until hitch clip rests in relief pocket on bottom of table two.

Thread table one (top table) onto top of 9/16″ pipe until threads on pipe are seated into the threaded hole on bottom of table one.

When table one is snug on threads of 9/16″ pipe, align the top and bottom octagon tables so the flat sides of octagon are even.

Stand height is adjustable by locating hitchclip pin in upper or lower position. 42+¾″ tall for electric guitars and 44+⅞″ tall for electric basses and acoustic guitars.

Stand is now ready to use.

### SHAFT ONE, SHAFT TWO, CAP, MOUNTING TUBE AND LEGS: SIDE VIEW

### Shaft One

9/16″ outside diameter pipe 30″ long, threaded 24 threads per inch at top and flared to ¾″ at bottom.

Two 7/32″ holes drilled through horizontally at 21¼″ to center and 23+⅜″ to center, measuring down from top (threaded end).

### Shaft Two

⅞″ outside diameter pipe with ¾″ inside diameter.

Pipe is 15½″ long

Threaded cap with 9/16″ hole in center (top side).

Bottom of 15½″ long pipe is riveted into a three leg tripod shaped base.

Top of base is 1″ outside diameter pipe, 2¾″ long to hold and stabilize the 15½″ vertical pipe. (This is the part the ¾″ pipe is riveted to.)

The bottom of pipe is 4″ off floor, supported by the three 13″ long by ¾″ OD legs with rubber caps at floor end, that make up the bottom of the tripod shaped base.

Legs are welded onto the 1″ pipe at a 20 degree angle from floor up to 4″ off floor. During manufacturing, legs may be pinned at bottom to allow folding.

### TABLE ONE/TOP TABLE: TOP VIEW

18″×18″ octagon with 4 cutouts on opposing sides in center of outermost sides. (North, south, east, west configuration.)

Each cutout is 3½″ deep from outside to innermost part of cutout.

Outside width is 3″

Inside width is 1½″ at center of 1½″ half circle.

1½″ half circle is innermost part of cutout

Two opposing sides of octagon without cutouts, drill ¼″ vertical hole 1″ to center of hole from outside edge and center hole in the very center of outermost side.

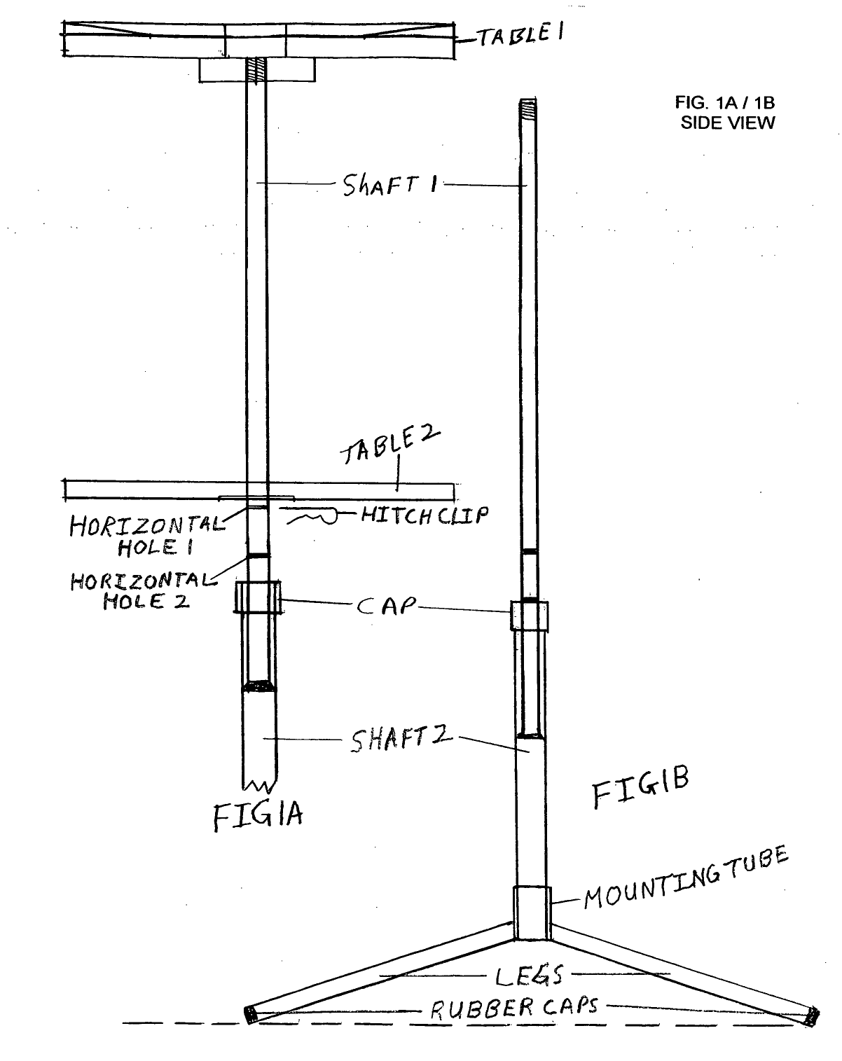

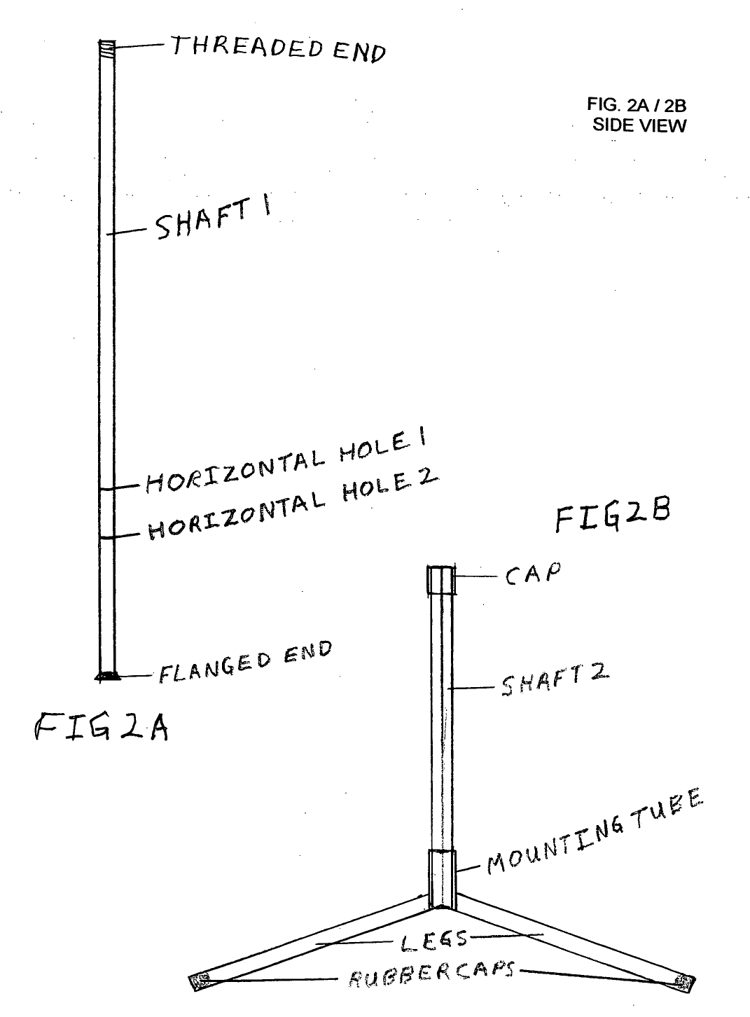

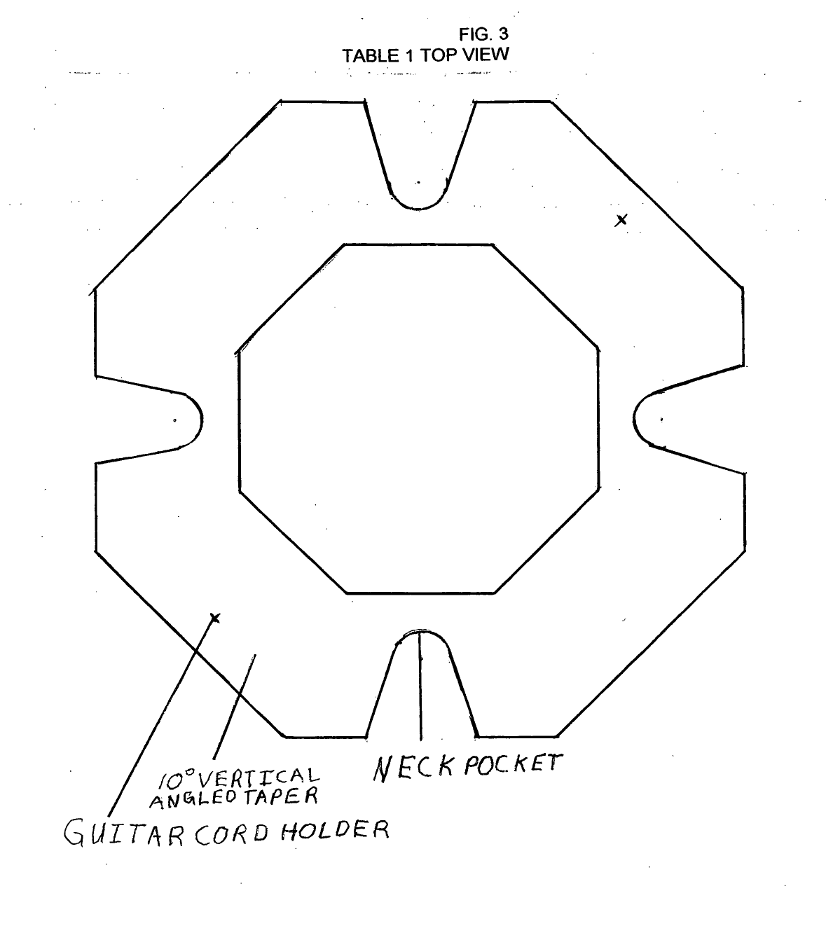

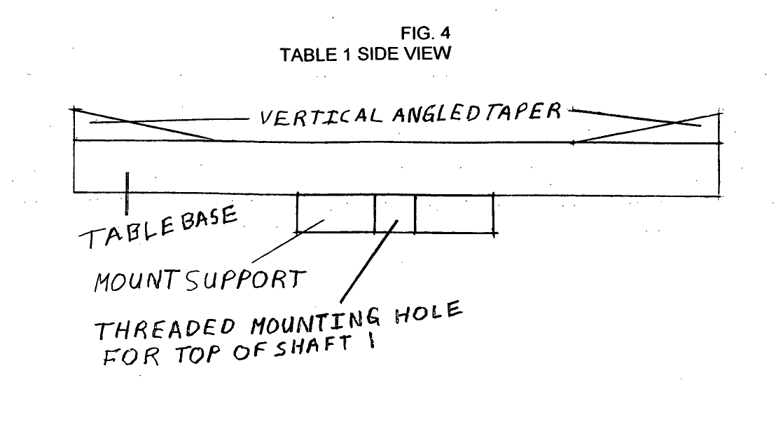

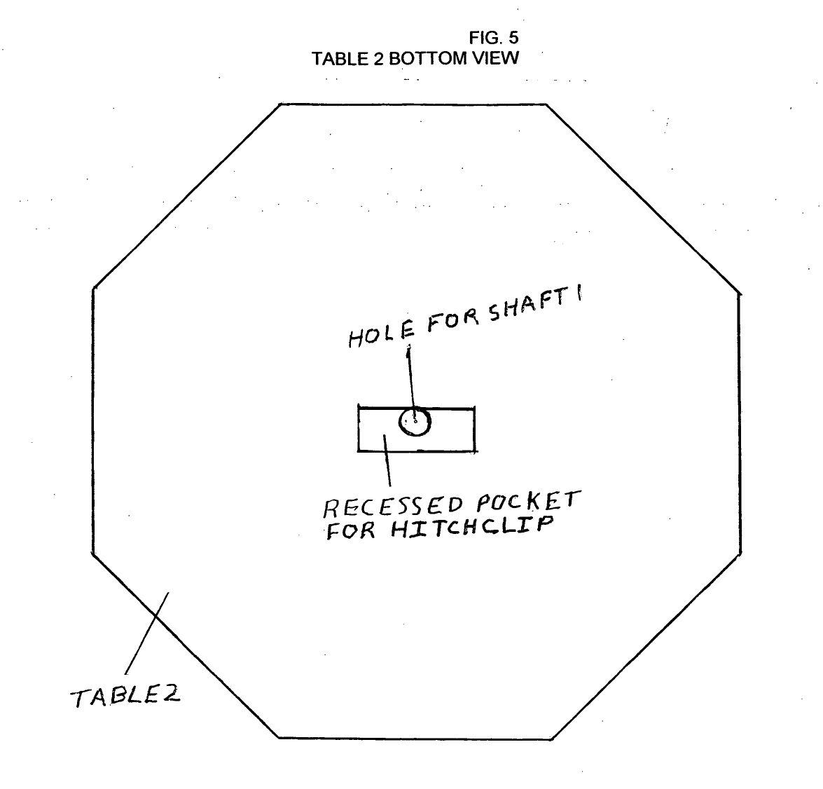

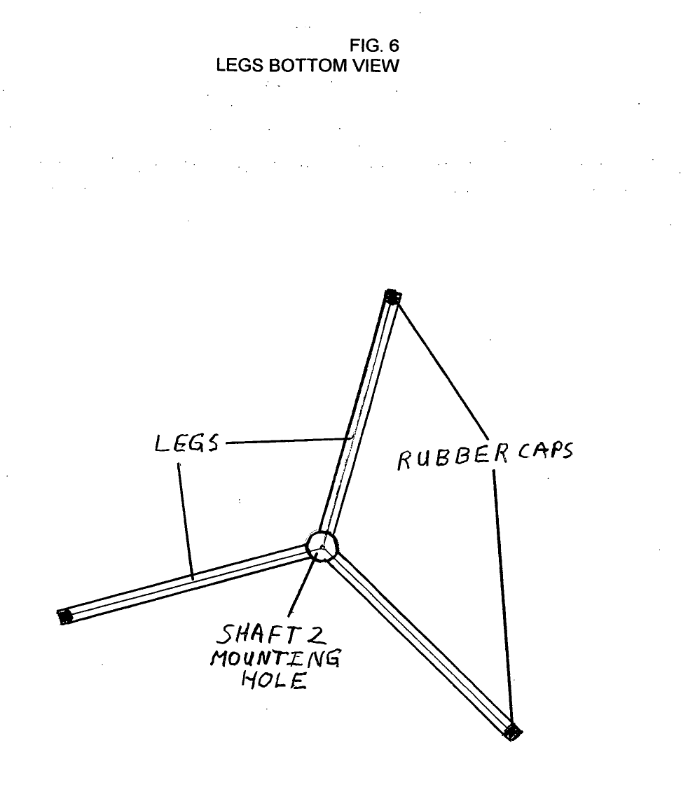

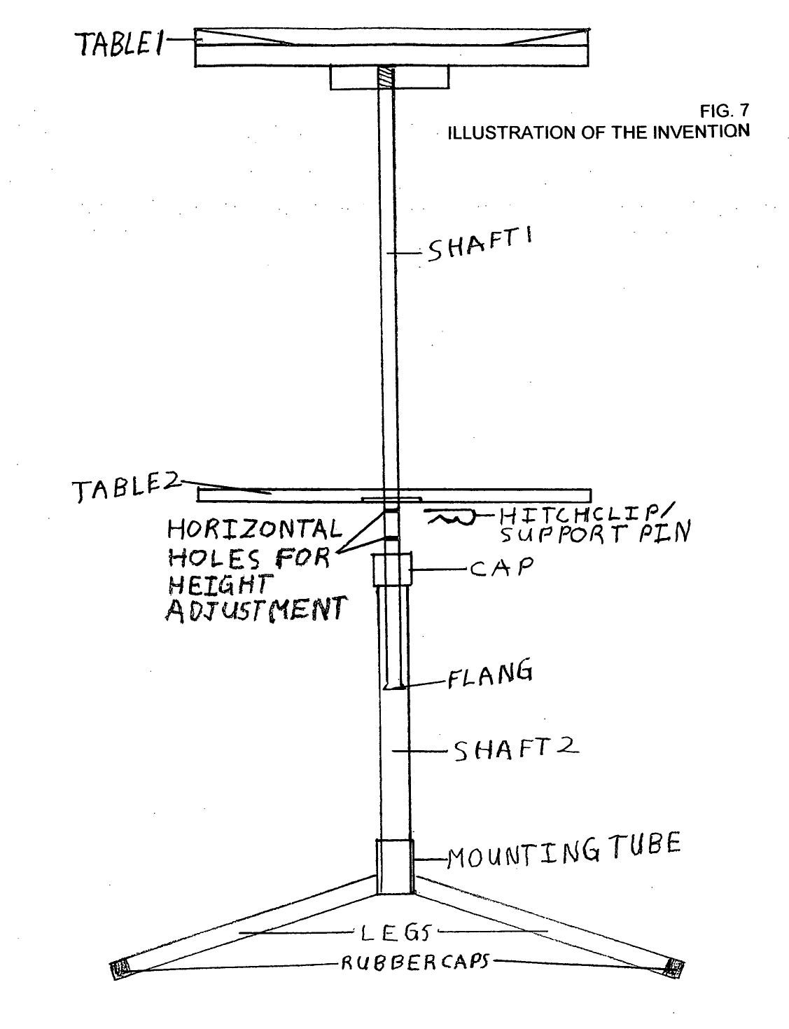

Inside octagon shape is the inside edge of angle, from innermost edge to outside edge, tapered from 0 to ⅝″ creating a concave top view. (More detail FIG. 1D)

Angle is 4″ wide from outside edge to inside edge on top side of table one.

Protective covering is applied to table tops upon completion.

### TABLE ONE/TOP TABLE: SIDE VIEW SHOWN AT ⅓ SCALE

18″ wide by 1+⅛″ thick, outside angles are 4″ wide and tapered 0 to ⅝″ thick at outside edge totaling 1¾″ at outside edge.

Center of bottom is 5½″ by 1″ thick octagon shaped centered on bottom with 9/16″ hole at center.

Center hole is threaded 24 threads per inch.

### TABLE TWO/BOTTOM TABLE: BOTTOM VIEW

18″ by 18″ octagon ½″ thick

9/16″ hole drilled all the way through at exact center.

⅛″ deep pocket for hitch clip to set in, measuring 3½″

Wide centered at 9/16″ hole and 1+⅛″ high from top of 9/16″ hole down.

Top of table two/bottom table is flat and smooth with no machining.

Protective covering added to table

### TRIPOD SHAPED BASE LEGS: BOTTOM VIEW

The three legs are positioned at 120 degrees from each other in a 26″ radius on floor, making base very stable.

At time of manufacturing, legs may be pinned instead of welded, to allow folding.

Rubber caps applied to outer end of legs to prevent floor surface damage and slipping.

### ILLUSTRATION OF THE INVENTION

Assembled stand side view prototype complete.

1. Spinable quad guitar stand vs others:
Holds one to four guitars or electric basses.
Spins for easy access to instruments and accessories
Space saving design fits nicely, even in corners
Is sturdy and well balanced
Safely holds guitars and basses so they cannot be knocked over.
Two position adjustable height to accommodate longer bodied guitars and basses.
Supports instruments by headstock instead of bottom of body as most, preventing the instrument from tipping over and falling on the floor, if bumped.
Has two tables for easy access to picks, strings, tuners, cords, etc.
Top table has two drilled holes for inserting the end of musicians guitar cords for easy plug and play ability. This is an additional benefit for musicians who switch instruments during performances, as cord is easily accessible. Top table is designed with concave top which holds and prevents tuners, strings, keys, phones, etc from vibrating off the stand table and falling to the floor.
As a professional musician, I require a sturdy guitar stand which is able to safely accommodate up to four guitars, and will not tip or tumble when bumped, during stage performances. I need to be able to access any of my multiple guitars without tripping over the stand, or having the guitars get hung up on stand apparatus. I also want to be able to easily access tuners, picks, cords, extra strings, winders, etc.
I am a fender certified luthier and repair technician. I handcraft my own design of bass and guitar. I require display/storage stands for these items which will not take up a lot of floor space. I was not able to find any stands on the market suitable for my needs. Taking these things into consideration, I designed and crafted this spinable guitar stand which satisfies my needs in all arenas.
I built the first spinable guitar stand on May 1, 2012, and began using it. On Jun. 12, 2012, I drew up the plan layout and sent the drawings to myself via USPS for protection. (Included in drawings). Within a few months I was able to perfect the stand and now I have time to patent and begin the process of making the stand available to the general public.
I invented this spinable guitar stand to display and protect multiple instruments in a confined amount of space. The spinable guitar stand holds one to four guitars. The owner can spin the stand to easily access any of the guitars mounted and any objects stored on tables. This stand is beneficial for storing guitars and basses in confined spaces in homes, music studios, on stage, and in stores for display. The stand is well balanced so it will not tip when removing any of the instruments.
I included tables on the stand and designed them to hold securely, any items which would be needed for performances, repairs, etc.
The prototype pictured was made from building items I have on hand including wood, steel pipe, and protective coverings. During research and development for the manufacturing process I expect variables in the materials used to complete the retail product. Including plastics, colors, textures, protective coverings, etc. These things will be considered at point of manufacture. The height, shape, design, and purpose will remain the same. Variables will not affect the design and usability of the product.
